(19) United States
(12) Patent Application Publication
(10) Pub. No.: US 2025/0192294 A1
(43) Pub. Date: Jun. 12, 2025

(54) CYLINDRICAL BATTERY

(71) Applicant: Panasonic Energy Co., Ltd., Osaka (JP)

(72) Inventor: Shota YATOMI, Tokushima (JP)

(21) Appl. No.: 18/845,336

(22) PCT Filed: Mar. 3, 2023
(86) PCT No.: PCT/JP2023/008048

§ 371 Date: Sep. 9, 2024

(30) Foreign Application Priority Data
Mar. 18, 2022 (JP) 2022-043370

(51) Int. Cl. H01M 50/184; H01M 10/0587; H01M 50/107

(52) U.S. Cl. CPC H01M 50/184; H01M 10/0587; H01M 50/107

(57) ABSTRACT

A cylindrical battery comprises: an electrode body in which a positive electrode and a negative electrode are wound with a separator therebetween; a bottomed cylindrical external can in which the electrode body is housed; a sealing body that seals the opening of the external can; and a gasket that insulates the external can and the sealing body. One or more tapered grooves including a tapered section that tapers toward the electrode body side are provided to the outer surface of the gasket.

### TECHNICAL FIELD

The present disclosure relates to a cylindrical battery.

### BACKGROUND

In recent years, applications of cylindrical batteries have been continuously expanding, and the cylindrical batteries have been used in a wide variety of applications, for example, in-vehicle applications such as hybrid vehicles (HV) and electric vehicles (EV), information terminal applications such as notebook computers, smartphones, and tablet computers, and mounting applications of electric tools and assist bicycles. The cylindrical battery is required to have high reliability, for example, high reliability such as insulation properties of positive and negative electrodes and liquid leakage prevention performance of an electrolytic solution.

In this background, conventionally, there is a cylindrical battery described in Patent Literature 1. The cylindrical battery includes an exterior housing can, an electrode assembly housed in the exterior housing can, and a sealing assembly that closes an opening of the exterior housing can. The sealing assembly is caulked and fixed to the opening of the exterior housing can with a gasket interposed therebetween. The exterior housing can has a shoulder portion, a grooved portion, a cylindrical portion, and a bottom portion. The grooved portion is formed by recessing a part of the side surface of the exterior housing radially can inwards in an annular shape. The sealing assembly receives force on the opening portion side in the axial direction through the gasket from an annular protrusion protruding radially inwards due to formation of the grooved portion. The shoulder portion is formed by bending, when the sealing assembly is caulked and fixed to the exterior housing can, the upper end portion of the exterior housing can inwards toward a peripheral edge of the sealing assembly.

### CITATION LIST

### Patent Literature

### Patent Literature 1: JP 2000-48825 A

### SUMMARY

In a cylindrical battery of Patent Literature 1, a sealing property is secured by caulking fixation, but when an electrolytic solution is accumulated at a caulked portion, the electrolytic solution may crawl up a space between a gasket and an exterior housing can, and liquid leakage may occur. Alternatively, the electrolytic solution may crawl up a space between a sealing assembly and the gasket, which may cause liquid leakage. Therefore, an object of the present disclosure is to provide a cylindrical battery capable of suppressing leakage of an electrolytic solution from a sealed part.

In order to solve the above problems, a cylindrical battery according to the present disclosure includes: an electrode assembly in which a positive electrode and a negative electrode are wound with a separator interposed therebetween; a bottomed cylindrical exterior housing can configured to house the electrode assembly; a sealing assembly configured to seal an opening of the exterior housing can; and a gasket including an outer edge covering portion configured to hold, in an axial direction, an outer edge portion on an outer side in a radial direction of the sealing assembly and disposed so as to cover an outer peripheral surface of the outer edge portion, the gasket insulating the sealing assembly from the exterior housing can, in which the gasket has one or more tapered grooves provided on an outer surface thereof, each of the tapered grooves including a tapered portion tapered toward the electrode assembly.

According to the cylindrical battery of the present disclosure, liquid leakage of an electrolytic solution from a sealed part can be suppressed.

### BRIEF DESCRIPTION OF DRAWINGS

FIG. 1 is an axial cross-sectional view of a cylindrical battery according to an embodiment of the present disclosure.

FIG. 2 is a perspective view of an electrode assembly of the above cylindrical battery.

FIG. 3 is an enlarged cross-sectional view of a sealing assembly peripheral portion of the cylindrical battery.

FIG. 4 is an enlarged cross-sectional view of a periphery of a shoulder portion of an exterior housing can in FIG. 3.

FIG. 5 is a schematic plan view of an annular gasket before deformation, which is incorporated into the above cylindrical battery, when viewed from below in the axial direction.

FIG. 6 is a schematic cross-sectional view when a cross section taken along line A-A of a dotted line in FIG. 4 is opened in a planar shape and is developed in a band shape in the circumferential direction as viewed in a plan view.

FIG. 7 is a schematic cross-sectional view of a cylindrical battery according to a first modification, corresponding to FIG. 6.

FIG. 8 is a schematic cross-sectional view of a cylindrical battery according to a second modification, corresponding to FIG. 6.

FIG. 9 is an enlarged cross-sectional view of a cylindrical battery according to a third modification, corresponding to FIG. 4.

### DESCRIPTION OF EMBODIMENTS

Hereinafter, an embodiment of a cylindrical battery according to the present disclosure will be described in detail with reference to the drawings. It is noted that the cylindrical battery of the present disclosure may be a primary battery or a secondary battery. In addition, the battery may be a battery using an aqueous electrolyte or a battery using a non-aqueous electrolyte. Hereinafter, a non-aqueous electrolyte secondary battery (a lithium ion battery) using a non-aqueous electrolyte will be exemplified as a cylindrical battery 10 according to the embodiment, but the cylindrical battery of the present disclosure is not limited thereto.

In the following, in a case where a plurality of embodiments, modifications, and the like are included, it is assumed from the beginning to construct a new embodiment by appropriately combining these characteristic portions. In the following embodiments, the same components are denoted by the same reference numerals in the drawings, and redundant descriptions thereof will be omitted. In addition, a plurality of drawings include schematic views, and dimensional ratios such as a length, a width, and a height of each member do not necessarily coincide between different drawings. In the present specification, for convenience of description, a sealing assembly 17 side in the axial direction (height direction) of a battery case 15 is referred to as “upper”, and the bottom side of an exterior housing can 16 in the axial direction is referred to as “lower”. Among the constituent elements described below, constituent elements not recited in the independent claim indicating the highest concept are any constituent elements and are not essential constituent elements.

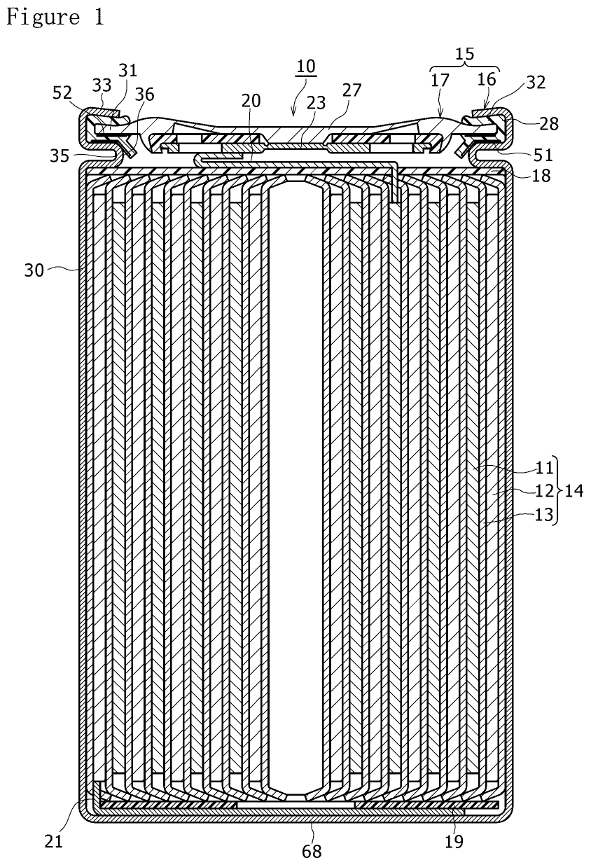

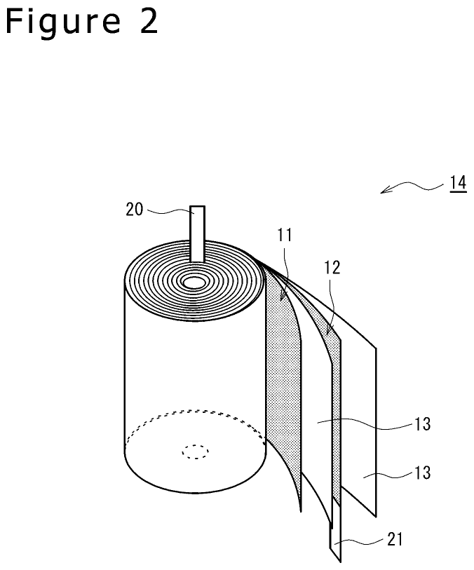

FIG. 1 is a cross-sectional view in the axial direction of a cylindrical battery 10 according to the embodiment of the present disclosure, and FIG. 2 is a perspective view of an electrode assembly 14 of the cylindrical battery 10. As shown in FIG. 1, the cylindrical battery 10 includes the wound electrode assembly 14, a non-aqueous electrolyte (not illustrated), and the battery case 15 that houses the electrode assembly 14 and the non-aqueous electrolyte. The battery case 15 includes the bottomed cylindrical exterior housing can 16 and the sealing assembly 17 that closes an opening of the exterior housing can 16. The cylindrical battery 10 includes a resin gasket 28 disposed between the exterior housing can 16 and the sealing assembly 17.

The non-aqueous electrolyte includes a non-aqueous solvent and an electrolyte salt dissolved in the non-aqueous solvent. As the non-aqueous solvent, for example, esters, ethers, nitriles, amides, and mixed solvents of two or more materials selected from thereamong may be used. The non-aqueous solvent may contain a halogen-substituted product in which at least some hydrogen in the solvent described above is substituted with a halogen atom such as fluorine. It is noted that the non-aqueous electrolyte is not limited to a liquid electrolyte, and may be a solid electrolyte using a gel polymer or the like. As the electrolyte salt, a lithium salt such as LiPF₆ is used.

As shown in FIG. 2, the electrode assembly 14 includes an elongated positive electrode 11, an elongated negative electrode 12, and two elongated separators 13, and has a wound structure in which the positive electrode 11 and the negative electrode 12 are wound with the separator 13 interposed therebetween. A positive electrode lead 20 is joined to the positive electrode 11 of the electrode assembly 14, and a negative electrode lead 21 is joined to the negative electrode 12 of the electrode assembly 14. The negative electrode 12 is formed to have a size slightly larger than that of the positive electrode 11 in order to suppress precipitation of lithium, and is formed to be longer than the positive electrode 11 in the longitudinal direction and the width direction (lateral direction). Further, the two separators 13 are formed to have a size slightly larger than that of at least the positive electrode 11, and, for example, are disposed so as to sandwich the positive electrode 11.

The positive electrode 11 includes a positive electrode current collector and a positive electrode mixture layer formed on both surfaces of the current collector. As the positive electrode current collector, a foil of a metal, such as aluminum or an aluminum alloy, that is stable in a potential range of the positive electrode 11, a film in which the metal is disposed on its surface layer, or the like can be used. The positive electrode mixture layer contains a positive electrode active material, a conductive agent, and a binding agent. The positive electrode 11 can be produced by, for example, applying a positive electrode mixture slurry including the positive electrode active material, the conductive agent, the binding agent, and the like onto the positive electrode current collector, drying an applied film, and then compressing the film so as to form the positive electrode mixture layer on both surfaces of the current collector.

The positive electrode active material is mainly composed of a lithium-containing metal composite oxide. Examples of the metal element contained in the lithium-containing metal composite oxide include Ni, Co, Mn, Al, B, Mg, Ti, V, Cr, Fe, Cu, Zn, Ga, Sr, Zr, Nb, In, Sn, Ta, and W. An example of a preferred lithium-containing metal composite oxide is a composite oxide containing at least one of Ni, Co, Mn, and Al.

Examples of the conductive agent included in the positive electrode mixture layer include carbon materials such as carbon black, acetylene black, Ketjenblack, and graphite. Examples of the binding agent included in the positive electrode mixture layer include fluororesins such as polytetrafluoroethylene (PTFE) and polyvinylidene fluoride (PVdF), polyacrylonitrile (PAN), polyimide, acrylic resins, and polyolefin. These resins may be used in combination with a cellulose derivative such as carboxymethyl cellulose (CMC) or its salt, polyethylene oxide (PEO), or the like.

The negative electrode 12 includes a negative electrode current collector and a negative electrode mixture layer formed on both surfaces of the current collector. As the negative electrode current collector, a foil of a metal, such as copper or a copper alloy, that is stable in a potential range of the negative electrode 12, a film in which the metal is disposed on its surface layer, or the like can be used. The negative electrode mixture layer contains a negative electrode active material and a binding agent. The negative electrode 12 can be produced, for example, by applying a negative electrode mixture slurry containing a negative electrode active material, a binding agent, and the like onto the negative electrode current collector, drying an applied film, and then compressing the film so as to form the negative electrode mixture layer on both surfaces of the current collector.

As the negative electrode active material, a carbon material that reversibly occludes and releases lithium ions is generally used. Preferable examples of the carbon material include natural graphite such as flake graphite, massive graphite, and amorphous graphite, and artificial graphite such as massive artificial graphite and graphitized mesophase-carbon microbead. The negative electrode mixture layer may contain a Si-containing compound as the negative electrode active material. Further, as the negative electrode active material, a metal to be alloyed with lithium other than Si, an alloy containing the metal, a compound containing the metal, or the like may be used.

As the binding agent contained in the negative electrode mixture layer, a fluororesin, PAN, a polyimide resin, an acrylic resin, a polyolefin resin, or the like may be used as in the case of the positive electrode 11, but styrene-butadiene rubber (SBR) or a modified product thereof is preferably used. The negative electrode mixture layer may contain, for example, CMC or a salt thereof, polyacrylic acid (PAA) or a salt thereof, polyvinyl alcohol, or the like in addition to SBR or the like.

As the separator 13, a porous sheet having an ion permeation property and an insulation property is used. Specific examples of the porous sheet include fine porous thin films, woven fabrics, nonwoven fabrics, and the like. As a material of the separator 13, olefin resins such as polyethylene and polypropylene, cellulose, and the like are preferable. The separator 13 may have either a single-layered structure or a multilayered structure. On the surface of the separator 13, a heat-resistant layer or the like may be formed. It is noted that the negative electrode 12 may constitute the winding start end of the electrode assembly 14, but in general, the separator 13 extends beyond the winding star side end of the negative electrode 12, and the winding start side end of the separator 13 becomes the winding start end of the electrode assembly 14.

In the examples shown in FIGS. 1 and 2, a positive electrode lead 20 is electrically connected to an intermediate portion such as a central portion in the winding direction of the positive electrode current collector, and the negative electrode lead 21 is electrically connected to the winding finish end portion in the winding direction of the negative electrode current collector. However, the negative electrode lead may be electrically connected to the winding start end portion in the winding direction of the negative electrode current collector. Alternatively, the electrode assembly may have two negative electrode leads, in which one of the negative electrode leads may be electrically connected to the winding start end portion in the winding direction of the negative electrode current collector, and the other negative electrode lead may be electrically connected to the winding finish end portion in the winding direction of the negative electrode current collector. Alternatively, the negative electrode may also be electrically connected to the exterior housing can by bringing the winding finish side end portion in the winding direction of the negative electrode current collector into contact with the inner surface of the exterior housing can. Alternatively, the negative electrode lead may be electrically connected to the winding start side end portion in the winding direction of the negative electrode current collector, and the winding finish side end portion in the winding direction of the negative electrode current collector may be brought into contact with the inner surface of the exterior housing can.

As shown in FIG. 1, the cylindrical battery 10 further includes an upper insulating plate 18 disposed on the upper side of the electrode assembly 14 and a lower insulating plate 19 disposed on the lower side of the electrode assembly 14. In the example shown in FIG. 1, the positive electrode lead 20 attached to the positive electrode 11 extends to the sealing assembly 17 side through a through hole of the upper insulating plate 18, and the negative electrode lead 21 attached to the negative electrode 12 extends to a bottom plate portion 68 side of the exterior housing can 16 through the outside of the lower insulating plate 19. The positive electrode lead 20 is connected to the lower surface of a terminal plate 23 which is a bottom plate of the sealing assembly 17 by welding or the like, and a valve body (rupture disk) 27 which is a top plate of the sealing assembly 17 electrically connected to the terminal plate 23 serves as a positive electrode terminal. Also, the negative electrode lead 21 is connected to the inner surface of the bottom plate portion 68 of the exterior housing can 16 by welding or the like, and the exterior housing can 16 serves as a negative electrode terminal.

The exterior housing can 16 is a metal container having a bottomed cylindrical portion. The exterior housing can 16 and the sealing assembly 17 are sealed with the annular gasket 28, and the internal space of the battery case 15 is closed by the sealing. In addition, the gasket 28 includes a sandwiching part 32 sandwiched between the exterior housing can 16 and the sealing assembly 17, and insulates the sealing assembly 17 from the exterior housing can 16. That is, the gasket 28 serves as a sealing material for maintaining airtightness inside the battery, and plays a role of preventing occurrence of liquid leakage of the electrolytic solution. Further, the gasket 28 also serves as an insulating material for preventing a short circuit between the exterior housing can 16 and the sealing assembly 17.

The exterior housing can 16 has a protrusion 36 protruding inwards in the radial direction on the inner peripheral side by providing an annular groove 35 in a part of the cylindrical outer peripheral surface of the exterior housing can 16 in the axial direction. The annular groove 35 can be formed, for example, by spinning a part of the cylindrical outer peripheral surface inwards in the radial direction to be recessed inwards in the radial direction. The exterior housing can 16 has a bottomed cylindrical portion 30 including the protrusion 36 and an annular shoulder portion 33. The bottomed cylindrical portion 30 accommodates the electrode assembly 14 and the non-aqueous electrolyte, and the shoulder portion 33 is bent inwards in the radial direction from the end portion on the opening side of the bottomed cylindrical portion 30 and extends inwards. The shoulder portion 33 is formed when the upper end portion of the exterior housing can 16 is bent inwards and caulked to a peripheral edge 31 of the sealing assembly 17. The sealing assembly 17 is held by the shoulder portion 33 and the upper side of the protrusion 36 together with the gasket 28 by caulking thereof, and is fixed to the exterior housing can 16.

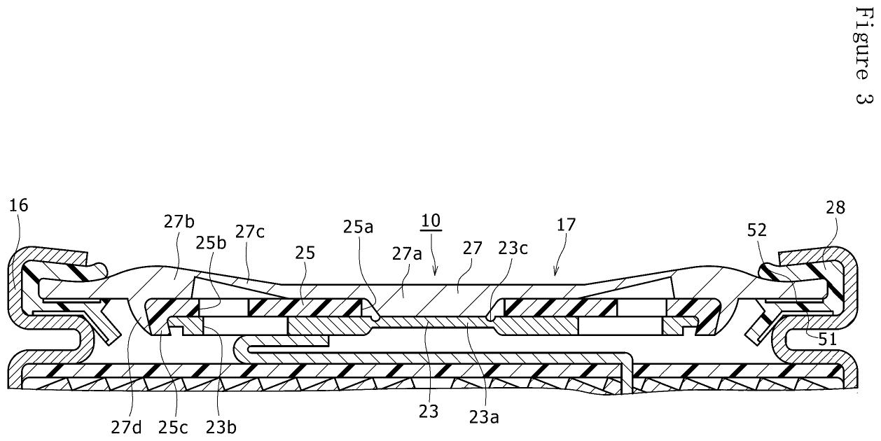

Next, the sealing assembly 17 will be described in detail. FIG. 3 is an enlarged cross-sectional view of a sealing assembly peripheral portion of the cylindrical battery 10. As shown in FIG. 3, the sealing assembly 17 has a structure in which the terminal plate 23, an annular insulating plate 25, and a valve body 27 are stacked in this order from the electrode assembly 14 side. The valve body 27 has a circular shape in a plan view. The valve body 27 can be manufactured by, for example, pressing a plate material of aluminum or an aluminum alloy. Since aluminum and an aluminum alloy are excellent in flexibility, they are preferable as a material of the valve body 27.

A thin portion 27c is formed at an intermediate portion connecting a central portion 27a to an outer peripheral portion 27b of the valve body 27. When the battery internal pressure rises, the thin portion 27c is reversed and broken, so that the valve body 27 functions as an explosion-proof valve. The central portion 27a is formed so as to protrude toward the terminal plate 23, thereby facilitating connection between the valve body 27 and the terminal plate 23.

The insulating plate 25 is formed to have an annular shape in a plan view and has a through hole 25a at a central portion thereof. The insulating plate 25 is fitted and fixed to an annular protrusion 27d formed to protrude downwards in the outer peripheral portion 27b of the valve body 27. The insulating plate 25 is provided to ensure an insulation property. The insulating plate 25 is preferably made of a material that does not affect battery characteristics. An example of the material of the insulating plate 25 includes a polymer resin, and examples thereof include a polypropylene (PP) resin and a polybutylene terephthalate (PBT) resin. The insulating plate 25 has a vent hole 25b that penetrates the insulating plate in the axial direction on the outer peripheral side thereof. Further, the insulating plate 25 has an annular skirt 25c extending downwards at the outer peripheral edge thereof.

The terminal plate 23 has a circular outer shape having a smaller diameter than that of the insulating plate 25 in a plan view, and a central portion 23a is a thin portion. The terminal plate 23 is disposed to face the valve body 27 with the insulating plate 25 interposed therebetween. The terminal plate 23 is attached to the insulating plate 25 by internally fitting and fixing its outer peripheral surface to the inner peripheral surface of the skirt 25c of the insulating plate 25. The central portions of the valve body 27 and the terminal plate 23 are connected to each other via the through hole 25a of the insulating plate 25.

Similarly to the valve body 27, the terminal plate 23 is preferably formed of aluminum or an aluminum alloy, and in this way, and it is possible to easily connect the central portions of the valve body 27 and the terminal plate 23 to each other. As a connection method, metallurgical joining is preferably used, and laser welding is exemplified as the metallurgical joining. The vent hole 23b penetrating the terminal plate 23 in the axial direction is formed on the outer peripheral side of the terminal plate 23. The vent hole 23b communicates with the vent hole 25b of the insulating plate 25. An inner peripheral surface of the skirt 25c may have a truncated cone shape in which the inner diameter decreases toward the lower side, and the outer peripheral surface of the terminal plate 23 may have a truncated cone shape corresponding to the inner peripheral surface. In such a case, by press-fitting and fixing the terminal plate 23 to the skirt 25c, the positional shift of the terminal plate 23 relative to the valve body 27 can be reliably prevented.

In the cylindrical battery of the present disclosure, one or more tapered grooves including a tapered portion tapered toward the electrode assembly side are provided on the outer surface of the gasket. An electrolytic solution accumulates at a caulking portion of the cylindrical battery, and the electrolytic solution crawls up between the gasket and the exterior housing can, which may cause liquid leakage. Alternatively, the electrolytic solution may crawl up between the sealing assembly and the gasket, which may cause liquid leakage. According to the cylindrical battery of the present disclosure, the gasket has the one or more tapered grooves including the tapered portion that is tapered toward the electrode assembly side on the outer surface thereof, and thus the electrolytic solution accumulated at the caulked portion flows toward the tip side (electrode assembly side) of the tapered groove due to a capillary phenomenon, and crawling up of the electrolytic solution at the caulked portion can be suppressed. Therefore, it is possible to improve airtightness of the gasket and to suppress liquid leakage from the cylindrical battery. It is noted that the depth of the tapered groove is preferably less than or equal to 50% of the thickness of the gasket before being incorporated into the cylindrical battery in order to ensure sufficient strength of the gasket.

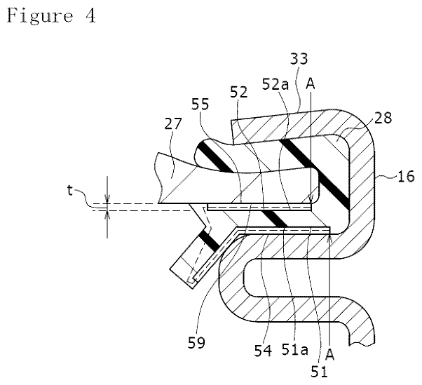

Hereinafter, the tapered groove provided in the gasket will be described in detail. In the cylindrical battery 10, on the outer surface of the gasket 28, a plurality of internal tapered grooves 51 that are tapered toward the electrode assembly 14 of the exterior housing can 16 and a plurality of external tapered grooves 52 that are tapered toward the electrode assembly 14 of the exterior housing can 16 are provided. FIG. 4 is an enlarged cross-sectional view of a periphery of a shoulder portion 38 of the exterior housing can 16 in FIG. 3. As illustrated in FIG. 4, the internal tapered groove 51 includes a lower tapered portion 51a provided on a lower surface 54 on the bottom plate portion 68 side of the exterior housing can 16 in the axial direction of the gasket 28 and tapered inwards in the radial direction, and in the present embodiment, the internal tapered groove 51 includes only the lower tapered portion 51a. Further, the external tapered groove 52 includes an upper tapered portion 52a provided on an upper surface 55 of the gasket 28 axially facing a lower surface 59 on the bottom plate portion 68 side of the exterior housing can 16 in the axial direction of the sealing assembly 17 and tapered inwards in the radial direction, and in the present embodiment, the external tapered groove 52 includes only the upper tapered portion 52a. A depth of the upper tapered portion 52a after the gasket 28 is incorporated into the cylindrical battery 10 is a length indicated by t in FIG. 4.

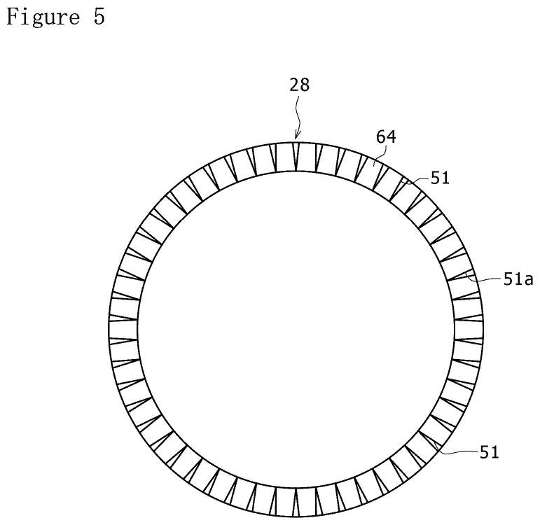

FIG. 5 is a schematic plan view of the annular gasket 28 before deformation that the cylindrical battery 10 is incorporated thereinto, when viewed from below in the axial direction. As illustrated in FIG. 5, a lower surface 64 of the annular gasket 28 before deformation is provided with a plurality of internal tapered grooves 51 at substantially equal intervals in the circumferential direction. Each of the internal tapered grooves 51 is a tapered groove the groove width of which becomes narrower toward the inside of the internal tapered groove 51 in the radial direction. Although the plurality of internal tapered grooves 51 are all substantially the same groove, the plurality of internal tapered grooves may include two or more tapered grooves having different shapes and/or sizes. Although the plurality of internal tapered grooves 51 are provided at equal intervals in the circumferential direction, the plurality of internal tapered grooves may be provided at non-equal intervals in the circumferential direction.

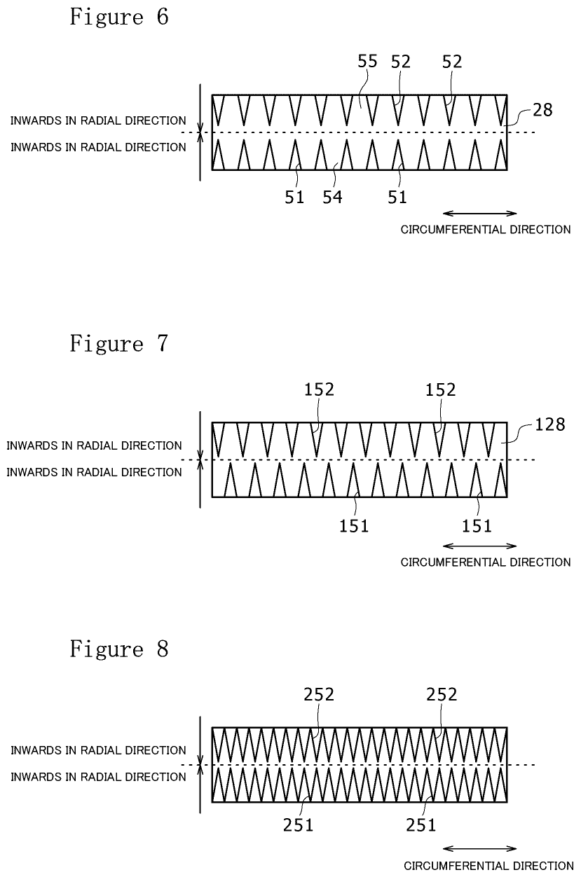

FIG. 6 is a schematic cross-sectional view when a cross section taken along line A-A of a dotted line in FIG. 4 is opened in a planar shape and is developed in a band shape in the circumferential direction as viewed in a plan view. As illustrated in FIG. 6, similarly to the internal tapered grooves 51, the plurality of external tapered grooves 52 are provided at equal intervals in the circumferential direction on the upper surface 55 of the gasket 28. Each of the external tapered grooves 52 is a tapered groove the groove width of which becomes narrower toward the inside of the external tapered groove 52 in the radial direction. Although the plurality of external tapered grooves 52 are all substantially the same groove, the plurality of external tapered grooves may include two or more tapered grooves having different shapes and/or sizes. Further, although the plurality of external tapered grooves 52 are provided at equal intervals in the circumferential direction, the plurality of external tapered grooves may be provided at non-equal intervals in the circumferential direction.

It is noted that the gasket 28 may have the plurality of internal tapered grooves 51 arranged at intervals over the entire circumference in the circumferential direction thereof, in which each of the intervals between the internal tapered grooves 51 is less than or equal to 45°, may have the plurality of internal tapered grooves 51 arranged at intervals over the entire circumference in the circumferential direction thereof, in which each of the intervals between the internal tapered grooves 51 is less than or equal to 30°, and may have the plurality of internal tapered grooves 51 arranged at intervals over the entire circumference in the circumferential direction thereof, in which each of the intervals between the internal tapered grooves 51 is less than or equal to 15°. In addition, the gasket 28 may have the plurality of internal tapered grooves 51 arranged at intervals over the entire circumference in the circumferential direction thereof, in which each of the intervals between the internal tapered grooves 51 is less than or equal to 10°, and may have the plurality of internal tapered grooves 51 arranged at intervals over the entire circumference in the circumferential direction thereof, in which each of the intervals between the internal tapered grooves 51 is less than or equal to 5°. When the plurality of internal tapered grooves 51 are disposed over the entire circumference of the gasket 28, liquid leakage from a space between the exterior housing can 16 and the gasket 28 can be effectively suppressed.

Similarly, the gasket 28 may have the plurality of external tapered grooves 52 arranged at intervals over the entire circumference in the circumferential direction thereof, in which each of the intervals between the external tapered grooves 52 is less than or equal to 45°, may have the plurality of external tapered grooves 52 arranged at intervals over the entire circumference in the circumferential direction thereof, in which each of the intervals between the external tapered grooves 52 is less than or equal to 30°, and may have the plurality of external tapered grooves 52 arranged at intervals over the entire circumference in the circumferential direction thereof, in which each of the intervals between the external tapered grooves 52 is less than or equal to 15°. In addition, the gasket 28 may have the plurality of external tapered grooves 52 arranged at intervals over the entire circumference in the circumferential direction thereof, in which each of the intervals between the external tapered grooves 52 is less than or equal to 10°, and may have the plurality of external tapered grooves 52 arranged at intervals over the entire circumference in the circumferential direction thereof, in which each of the intervals between the external tapered grooves 52 is less than or equal to 5°. When the plurality of external tapered grooves 52 are disposed over the entire circumference of the gasket 28, liquid leakage from a space between the sealing assembly 17 and the gasket 28 can be effectively suppressed

As illustrated in FIG. 6, each of the internal tapered grooves 51 and the external tapered grooves 52 is a closed groove having a closed tip, but at least one of the internal tapered grooves and the external tapered grooves may have an open tip instead of the closed tip. Further, each of the internal tapered groove 51 and the external tapered groove 52 has an isosceles triangle shape in the schematic cross-sectional view illustrated in FIG. 6, but each of the internal tapered groove and the external tapered groove may have a shape tapered inwards in the radial direction in the schematic cross-sectional view corresponding to FIG. 6, and may not have the isosceles triangle shape in the schematic cross-sectional view.

As illustrated in FIG. 6, the circumferential positions of the tips of the plurality of internal tapered grooves 51 substantially coincide with the circumferential positions of the tips of the plurality of external tapered grooves 52. However, in FIG. 7, that is, as illustrated in a schematic cross-sectional view corresponding to FIG. 6 in the cylindrical battery of a first modification, a plurality of internal tapered grooves 151 and a plurality of external tapered grooves 152 may be arranged such that the circumferential positions of the tips of the plurality of internal tapered grooves 151 and the circumferential positions of the tips of the plurality of external tapered grooves 152 alternately appear in the circumferential direction. In this manner, it is preferable that the tip of the internal tapered groove 151 and the tip of the external tapered groove 152 do not face each other, thereby making it easy to secure sufficient strength of the gasket 128.

In addition, as illustrated in FIG. 8, that is, a schematic cross-sectional view corresponding to FIG. 6 in a cylindrical battery of a second modification, two internal tapered grooves 251 adjacent to each other in the circumferential direction have wide end portions located on the opposite side of the tapered sides, in which the wide end portions may communicate with each other in the circumferential direction, and the plurality of internal tapered grooves 251 may be continuously provided in the circumferential direction over the entire circumferential range. In addition, two external tapered grooves 252 adjacent to each other in the circumferential direction also have wide end portions located on the opposite sides of the tapered sides, in which the wide end portions may communicate with each other in the circumferential direction, and the plurality of external tapered grooves 252 may also be continuously provided in the circumferential direction in the entire circumferential range.

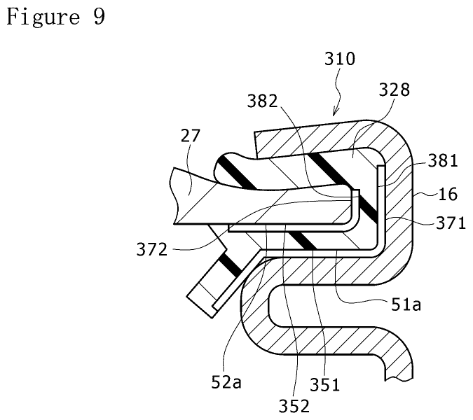

Further, in the cylindrical battery of the present disclosure, one of the internal tapered grooves and the external tapered grooves may not be present, only one or more internal tapered grooves may be present, or only one or more external tapered grooves may be present. In addition, in the cylindrical battery of the present disclosure, at least a part of the tapered groove may be present on the gasket side, as illustrated in the following FIG. 9.

FIG. 9 is an enlarged sectional view of a cylindrical battery 310 according to a third modification, corresponding to FIG. 4. As illustrated in FIG. 9, at least one of one or more internal tapered grooves 351 may include an outer peripheral tapered portion 381 that is provided at an outer-peripheral-side axially extending portion 371 facing the exterior housing can 16 and extending in the axial direction in a gasket 328 and that is tapered toward the bottom plate portion side of the exterior housing can 16 in the axial direction. The end portion of the outer peripheral tapered portion 381 on the bottom plate portion 68 side in the axial direction may communicate with the end portion of the lower tapered portion 51a on the outer side in the radial direction.

Similarly, at least one of the one or more external tapered grooves 352 may include an inner peripheral tapered portion 382 that is provided at an inner-peripheral-side axially extending portion 372 facing an outer peripheral surface 27e of the sealing assembly 17 and extending in the axial direction in the gasket 328 and that is tapered toward the bottom plate portion side of the exterior housing can 16 in the axial direction. Accordingly, the end portion of the inner peripheral tapered portion 382 on the bottom plate portion 68 side in the axial direction may communicate with the end portion of the upper tapered portion 52a on the outer side in the radial direction.

It is noted that, in the cylindrical battery of the present disclosure, only the one or more internal tapered grooves 351 described in FIG. 9 may be present in the gasket, and the external tapered grooves 352 described in FIG. 9 may not be present in the gasket. Conversely, in the cylindrical battery of the present disclosure, only the one or more external tapered grooves 352 described in FIG. 9 may be present in the gasket, and the internal tapered grooves 351 described in FIG. 9 may not be present in the gasket.

Further, the gasket 328 may have the plurality of internal tapered grooves 351 which are disposed at intervals in the circumferential direction over the entire circumference in the circumferential direction and include the outer peripheral tapered portion 381 and the lower tapered portion 51a. Further, the gasket 328 may have the plurality of external tapered grooves 352 which are disposed at intervals in the circumferential direction over the entire circumference in the circumferential direction and include the inner peripheral tapered portion 382 and the upper tapered portion 52a.

### First Embodiment

### (Preparation of Positive Electrode)

Li (Ni_{0.8}Co_{0.15}Al_{0.05}) O₂ was used as a positive electrode active material. 100 parts by mass of a positive electrode active material, 2.0 parts by mass of polyvinylidene fluoride as a binding agent, and 2.0 parts by mass of acetylene black as a conductive agent were mixed with a liquid component (NMP) to prepare a positive electrode mixture paste. The positive electrode mixture paste was applied to both surfaces of a positive electrode current collector made of an aluminum foil except for a connection portion of a positive electrode lead, and dried to form a positive electrode mixture layer. A prepared precursor of a positive electrode was compressed to obtain a positive electrode. The connection portion of the positive electrode lead was formed at the central portion of the positive electrode.

### (Preparation of Negative Electrode)

Graphite was used as a negative electrode active material. 100 parts by mass of a negative electrode active material, 1.0 parts by mass of polyvinylidene fluoride as a binding agent, 1.0 parts by mass of carboxymethyl cellulose as a thickening agent, and an appropriate amount of water were stirred with a double arm kneader to obtain a negative electrode paste. The negative electrode mixture paste was applied to both surfaces of a negative electrode current collector made of a copper foil except for a connection portion of a negative electrode lead, and dried to form a negative electrode mixture layer. A prepared precursor of a negative electrode was compressed to obtain a negative electrode. The connection portion of the negative electrode lead was formed at the winding finish end portion of the negative electrode.

### (Preparation of Electrode Assembly)

A positive electrode, a negative electrode, and a separator of a microporous membrane made of an olefin-based resin, which were prepared above using a winding core of Φ4, were wound with a winding machine, and a fastening tape having an insulation property was attached to the winding finish end, and then the fastening tape was removed from the winding core to prepare a wound electrode assembly.

### (Preparation of Non-aqueous Electrolyte)

In a non-aqueous solvent obtained by mixing ethylene carbonate and dimethyl carbonate at a volume ratio of 40: 60 (1 atm, converted to 25° C.), LiPF₆ as an electrolyte salt was dissolved at a concentration of 1.0M (mol/liter) to prepare a non-aqueous electrolyte.

### (Preparation of Cylindrical Battery)

An electrode assembly was inserted into an exterior housing can having a height of 74.5 mm and a diameter of 21 mm, and a diameter of an opening was reduced. Next, an upper insulating plate made of phenol resin (GP) mixed with glass fibers and formed to have an outer diameter of 20 mm and a thickness of 0.3 mm was inserted. Thereafter, a positive electrode lead was welded to a sealing assembly in which a gasket (PP) having an insulation property was incorporated into an opening of the exterior housing can, the above non-aqueous electrolyte was injected, and an opening side end portion of the sealing assembly, the gasket, and the exterior housing can was caulked with a pressing machine, thereby preparing a cylindrical battery. As the gasket, a gasket in which an external tapered groove was provided only in a portion in contact with the lower surface of a valve body from the outer peripheral surface of the valve body (rupture disk) was used. The rated capacity of the cylindrical battery was 5.0 Ah.

### Second Embodiment

A cylindrical battery different from the cylindrical battery of the first embodiment was prepared, in which the cylindrical battery is different from the cylindrical battery of the first embodiment only in that a gasket in which an external tapered groove was provided only in a portion in contact with the lower surface of a valve body (rupture disk) was used. The rated capacity of the cylindrical battery was 5.0 Ah.

### Third Embodiment

A cylindrical battery different from the cylindrical battery of the first embodiment was prepared, in which the cylindrical battery is different from the cylindrical battery of the first embodiment only in that a gasket in which an internal tapered groove was provided only in a range from the outer peripheral surface in contact with the inner peripheral surface of an exterior housing can to a radially inner edge on the lower surface on the electrode assembly side in the axial direction was used. The rated capacity of the cylindrical battery was 5.0 Ah.

### Fourth Embodiment

A cylindrical battery different from the cylindrical battery of the first embodiment was prepared, in which the cylindrical battery is different from the cylindrical battery of the first embodiment only in that a gasket in which an internal tapered groove was provided only in a range up to a radially inner edge on the lower surface on the electrode assembly side in the axial direction was used. The rated capacity of the cylindrical battery was 5.0 Ah.

### Fifth Embodiment

A cylindrical battery different from the cylindrical battery of the first embodiment was prepared, in which the cylindrical battery is different from the cylindrical battery of the first embodiment only in that a gasket in which an external tapered groove was provided only in a portion in contact with the lower surface of a valve body from the outer peripheral surface of a valve body (rupture disk) and an internal tapered groove was provided only in a range from the outer peripheral surface in contact with the inner peripheral surface of an exterior housing can to a radially inner edge of the lower surface on the electrode assembly side in the axial direction was used. The rated capacity of the cylindrical battery was 5.0 Ah.

### Sixth Embodiment

A cylindrical battery different from the cylindrical battery of the first embodiment was prepared, in which the cylindrical battery is different from the cylindrical battery of the first embodiment only in that a gasket in which an external tapered groove was provided only in a portion in contact with the lower surface of a valve body from the outer peripheral surface of a valve body (rupture disk) and an internal tapered groove was provided only in a range from the lower surface on the electrode assembly side in the axial direction to the inner edge in the radial direction was used. The rated capacity of the cylindrical battery was 5.0 Ah.

### Seventh Embodiment

A cylindrical battery different from the cylindrical battery of the first embodiment was prepared, in which the cylindrical battery is different from the cylindrical battery of the first embodiment only in that a gasket in which an external tapered groove was provided only in a portion in contact with the lower surface of a valve body (rupture disk) and an internal tapered groove was provided only in a range from the outer peripheral surface in contact with the inner peripheral surface of an exterior housing can to a radially inner edge on the lower surface on the electrode assembly side in the axial direction was used. The rated capacity of the cylindrical battery was 5.0 Ah.

### Eighth Embodiment

A cylindrical battery different from the cylindrical battery of the first embodiment was prepared, in which the cylindrical battery is different from the cylindrical battery of the first embodiment only in that a gasket in which an external tapered groove was provided only in a portion in contact with the lower surface of a valve body (rupture disk) and an internal tapered groove was provided only in a range up to a radially inner edge on the lower surface on the electrode assembly side in the axial direction was used. The rated capacity of the cylindrical battery was 5.0 Ah.

### Comparative Example

A cylindrical battery different from the cylindrical battery of the first embodiment only in that a gasket having no tapered groove was used was prepared. The rated capacity of the cylindrical battery was 5.0 Ah.

### (Temperature Cycle Test)

For each of the cylindrical battery of the first to eighth embodiments and the cylindrical battery of the comparative example, a temperature cycle test was performed on five samples with a state of charge (SOC) set to 30%. Specifically, a cycle of maintaining a temperature of 85+2° C. for 6 hours and then maintaining a temperature of −40+2°° C. for 6 hours was repeated 10 times, and then the temperature of 20° C. was maintained for 24 hours. The presence or absence of liquid leakage at a caulked portion of the cylindrical battery after the test was confirmed, and the presence or absence of mass change of the cylindrical battery was confirmed.

### [Test Results]

TABLE 1

| | External | | | | Presence or | Presence or |
|---|---|---|---|---|---|---|
| | tapered | External | Internal | | absence of | absence of |
| | groove | tapered | tapered | Internal | liquid leakage | liquid leakage |
| | (valve body | groove | groove | tapered | from space | from space |
| | side to valve | (only valve | (can side to | groove | between valve | between |
| | body lower | body lower | lower | (only lower | body and | exterior housing |
| | surface) | surface) | surface) | surface) | gasket | can and gasket |
| Comparative | Absence | Absence | Absence | Absence | Presence (5/5) | Presence (5/5) |
| example | | | | | | |
| First | Presence | Absence | Absence | Absence | Absence (0/5) | Presence (5/5) |
| embodiment | | | | | | |
| Second | Absence | Presence | Absence | Absence | Absence (0/5) | Presence (5/5) |
| embodiment | | | | | | |
| Third | Absence | Absence | Presence | Absence | Presence (5/5) | Absence (0/5) |
| embodiment | | | | | | |
| Fourth | Absence | Absence | Absence | Presence | Presence (5/5) | Absence (0/5) |
| embodiment | | | | | | |
| Fifth | Presence | Absence | Presence | Absence | Absence (0/5) | Absence (0/5) |
| embodiment | | | | | | |
| Sixth | Presence | Absence | Absence | Presence | Absence (0/5) | Absence (0/5) |
| embodiment | | | | | | |
| Seventh | Absence | Presence | Presence | Absence | Absence (0/5) | Absence (0/5) |
| embodiment | | | | | | |
| Eighth | Absence | Presence | Absence | Presence | Absence (0/5) | Absence (0/5) |
| embodiment | | | | | | |

From the above test results, it has been confirmed that liquid leakage from the space between the valve body and the gasket can be prevented when the external tapered groove is provided in a portion of the gasket in contact with the lower surface of the valve body from the valve body side or the external tapered groove is provided only in a portion of the gasket in contact with the lower surface of the valve body. In addition, it has been confirmed that liquid leakage from the space between the exterior housing can and the gasket can be prevented by providing the internal tapered groove from the portion of the gasket in contact with the side of the exterior housing can to the lower surface of the gasket or providing the internal tapered groove only on the lower surface of the gasket. Therefore, according to the cylindrical battery of the present disclosure, crawling up of the electrolytic solution at the caulked portion can be suppressed, airtightness of the gasket can be improved, and liquid leakage from the cylindrical battery 10 can be suppressed. It is noted that, when the tapered groove is provided in a wide range in the gasket, the strength of the gasket deteriorates. Therefore, when the cylindrical battery of the eighth embodiment in which the formation range of the internal tapered groove is narrow and the formation range of the external tapered groove is also narrow is produced, not only liquid leakage from the space between the valve body and the gasket and liquid leakage from the space between the exterior housing can and the gasket can be effectively suppressed, but also gasket strength can be increased, thereby making it possible to effectively suppress gasket breakage.

The present disclosure is not limited to the above embodiment and the modifications thereof, and various improvements and changes can be made within the matters described in the claims of the present application and the scope equivalent thereto. For example, in the above embodiment, the tapered groove is not provided in a portion of the gasket facing the upper surface of the sealing assembly, but such a tapered groove may be provided. In addition, the outer tapered groove may be provided only in a portion of the gasket facing the side of the sealing assembly, or the inner tapered groove may be provided only in a portion of the gasket facing the inner peripheral surface of the exterior housing can in the radial direction. As shown in FIG. 1, a case in which the central portion of the axially upper end surface of the cylindrical battery 10 is recessed downwards in the axial direction has been described. However, the cylindrical battery of the present disclosure may be configured such that the central portion of the axially upper end surface protrudes upwards in the axial direction. Further, the tapered groove may include a tapered portion that is tapered toward the electrode assembly. The tapered groove may be tapered in all portions over the entire length, or may have a portion having the same groove width in a partial region in the extending direction.

### REFERENCE SIGNS LIST

10, 310 CYLINDRICAL BATTERY

11 POSITIVE ELECTRODE

12 NEGATIVE ELECTRODE

13 SEPARATOR

14 ELECTRODE ASSEMBLY

15 BATTERY CASE

16 EXTERIOR HOUSING CAN

17 SEALING ASSEMBLY

18 UPPER INSULATING PLATE

19 LOWER INSULATING PLATE

20 POSITIVE ELECTRODE LEAD

21 NEGATIVE ELECTRODE LEAD

23 TERMINAL PLATE

23a CENTRAL PORTION

23b VENT HOLE

25 INSULATING PLATE

25a THROUGH HOLE

25b VENT HOLE

25c SKIRT

27 VALVE BODY

27a CENTRAL PORTION

27b OUTER PERIPHERAL PORTION

27c THIN PORTION

27d PROTRUSION

27e OUTER PERIPHERAL SURFACE

28, 128, 328 GASKET

30 BOTTOMED CYLINDRICAL PORTION

31 PERIPHERAL EDGE

32 SANDWICHING PART

33 SHOULDER PORTION

35 ANNULAR GROOVE

36 PROTRUSION

51, 151, 251, 351 INTERNAL TAPERED GROOVE

51a LOWER TAPERED PORTION

52, 152, 252, 353 EXTERNAL TAPERED GROOVE

52a UPPER TAPERED PORTION

54 LOWER SURFACE OF GASKET

55 UPPER SURFACE OF GASKET AXIALLY OPPOSITE TO LOWER SURFACE OF SEALING ASSEMBLY

59 LOWER SURFACE OF SEALING ASSEMBLY

64 LOWER SURFACE OF GASKET BEFORE DEFORMATION

68 BOTTOM PLATE PORTION

371 OUTER-PERIPHERAL-SIDE AXIALLY EXTENDING PORTION

372 INNER-PERIPHERAL-SIDE AXIALLY EXTENDING PORTION

381 OUTER PERIPHERAL TAPERED PORTION

382 INNER PERIPHERAL TAPERED PORTION

1. A cylindrical battery comprising:
an electrode assembly in which a positive electrode and a negative electrode are wound with a separator interposed therebetween;
a bottomed cylindrical exterior housing can configured to house the electrode assembly;
a sealing assembly configured to seal an opening of the exterior housing can; and
a gasket including an outer edge covering portion configured to hold, in an axial direction, an outer edge portion on an outer side in a radial direction of the sealing assembly and disposed so as to cover an outer peripheral surface of the outer edge portion, the gasket insulating the sealing assembly from the exterior housing can,
wherein the gasket has one or more tapered grooves provided on an outer surface thereof, each of the tapered grooves including a tapered portion tapered toward the electrode assembly.

2. The cylindrical battery according to claim 1, wherein the one or more tapered grooves include one or more internal tapered grooves, each of the internal tapered grooves including a lower tapered portion provided on a lower surface on a bottom plate portion side of the exterior housing can in the axial direction of the gasket, the lower tapered portion being tapered inwards in the radial direction.

3. The cylindrical battery according to claim 1, wherein the one or more tapered grooves include one or more external tapered grooves, each of the external tapered grooves including an upper tapered portion provided on an upper surface of the gasket, the upper surface axially facing a lower surface on a bottom plate portion side of the exterior housing can in the axial direction of the sealing assembly, the upper tapered portion being tapered inwards in the radial direction.

4. The cylindrical battery according to claim 2, wherein at least one of the one or more internal tapered grooves includes an outer peripheral tapered portion provided at an outer-peripheral-side axially extending portion facing the exterior housing can and extending in the axial direction in the gasket, the outer peripheral tapered portion being tapered toward a bottom plate portion side of the exterior housing can in the axial direction, and an end portion of the outer peripheral tapered portion, the end portion being on the bottom plate portion side in the axial direction, communicates with an end portion of the lower tapered portion, the end portion being on an outer side in the radial direction.

5. The cylindrical battery according to claim 3, wherein at least one of the one or more external tapered grooves includes an inner peripheral tapered portion provided at an inner-peripheral-side axially extending portion facing an outer peripheral surface of the sealing assembly and extending in the axial direction in the gasket, the inner peripheral tapered portion being tapered toward the bottom plate portion side of the exterior housing can in the axial direction, and an end portion of the inner peripheral tapered portion, the end portion being on the bottom plate portion side in the axial direction, communicates with an end portion of the upper tapered portion, the end portion being on an outer side in the radial direction.

6. The cylindrical battery according to claim 2, wherein the gasket has a plurality of the internal tapered grooves arranged at intervals over an entire circumference in a circumferential direction thereof, wherein each of the intervals between the internal tapered grooves is less than or equal to 45°.

7. The cylindrical battery according to claim 3, wherein the gasket has a plurality of the external tapered grooves arranged at intervals over an entire circumference in a circumferential direction thereof, wherein each of the intervals between the external tapered grooves is less than or equal to 45°.
